(19) United States
(12) Patent Application Publication
(10) Pub. No.: US 2008/0304830 A1
(43) Pub. Date: Dec. 11, 2008

(54) PASSIVE OPTICAL NETWORK, EQUIPMENT AND METHOD FOR SUPPORTING MULTICAST SERVICE

(75) Inventors: Wei HUANG, Shenzhen (CN); Huafeng LIN, Shenzhen (CN); Jun ZHAO, Shenzhen (CN); Feng WANG, Shenzhen (CN); Tao JIANG, Shenzhen (CN); Jun CHEN, Shenzhen (CN); Yuntao WANG, Shenzhen (CN); Guo WEI, Shenzhen (CN)

Correspondence Address: Leydig, Voit & Mayer, Ltd;(for Huawei Technologies Co., Ltd), Two Prudential Plaza Suite 4900, 180 North Stetson Avenue, Chicago, IL, 60601, US

(73) Assignee: HUAWEI TECHNOLOGIES CO., LTD., Shenzhen (CN)

(21) Appl. No.: 12/177,803

(22) Filed: Jul. 22, 2008

Related U.S. Application Data
(63) Continuation of application No. PCT/CN2007/000233, filed on Jan. 22, 2007.

(30) Foreign Application Priority Data
Jan. 23, 2006 (CN) 200610001979.X

(51) Int. Cl. H04J 14/02

(52) U.S. Cl. 398/79

(57) ABSTRACT

A Wavelength Division Multiplexed Passive Optical Network (WDM-PON), an Optical Line Terminal, an Optical Network Unit, a multiplexer/demultiplexer, and a method for realizing multicast service in the WDM-PON are disclosed. The WDM-PON and the method for realizing multicast service according to the present invention can transmit multicast service to be multicasted or broadcasted using a single wavelength, and thus the bandwidth resource of the system can be effectively saved and complexity of the system can be reduced.

### CROSS-REFERENCE TO RELATED APPLICATIONS

This application is a continuation of International Patent Application No. PCT/CN2007/000233, filed Jan. 22, 2007, which claims priority to Chinese Patent Application No. 200610001979.X, filed Jan. 23, 2006, both of which are hereby incorporated by reference in their entirety.

### FIELD OF THE INVENTION

The present invention relates to Passive Optical Network (PON) technology, and more particularly to a Wavelength Division Multiplexed Passive Optical Network (WDM-PON) for supporting multicast service, an Optical Line Terminal (OLT) used in the WDM-PON, an Optical Network Unit (ONU), a multiplexer/demultiplexer, and a method for realizing multicast service using the WDM-PON.

### BACKGROUND

With the development of high speed data service, such as video information service with high quality, Video on Demand (VoD), etc., users' requirements for data access bandwidth of an access network is up to about 100 Mbps. The current access manners, such as dial-up, Asymmetrical Digital Subscriber Loop (ADSL), etc., could not meet the users' bandwidth requirements; therefore the demand for constructing an access network with fibers increases quickly. The PON is a user access network that could meet the bandwidth requirements for the above high speed data service, which is cost-saved and convenient for operation and maintenance.

The infrastructure of the current PON is shown in FIG. 1. Generally, the PON mainly includes: an OLT located in the central office, an Optical Distribution Network (ODN) and multiple ONUs. The ODN conventionally consists of a multiplexer/demultiplexer and fibers for connecting the multiplexer/demultiplexer with the OLT and ONUs. The multiplexer/demultiplexer is configured to demultiplex an optical signal from the OLT and transmit demultiplexed optical signals to each of the ONUs respectively. The multiplexer/demultiplexer is also configured to multiplex optical signals from each of the ONUs and output a multiplexed optical signal to the OLT.

According to different realization mechanisms, the PON may be classified into a plurality of different types, such as, the Asynchronous Transfer Mode over PON (ATM-PON) which is based on ATM, the Ethernet over PON (EPON) which is based on Ethernet, the Gigabit PON (GPON) which has a rate of gigabits, the WDM-PON which is in combination with WDM technique, the Optical Code Division Multiple Access Passive Optical Network (OCDMA-PON) which is in combination with Code Division Multiple Access (CDMA) technique, etc.

The WDM-PON is of a point-to-point network structure. A point-to-point network conventionally transmits multicast service data in a manner of multiple replication in-band. On one hand, high processing capability of the OLT is required, and a complex multicast protocol is necessary for supporting the multicast service. Particularly, when the same program is demanded by many users, the processing capability of the OLT becomes the bottleneck of the WDM-PON system. On the other hand, because the same data needs to be replicated respectively at different wavelengths so as to be transmitted to different ONUs, the bandwidth resource of the system is wasted.

### SUMMARY

Embodiments of the present invention provide a WDM-PON which can save the bandwidth resource of the system and decrease the requirements for the processing capability of an OLT.

Embodiments of the present invention further provide an OLT, a multiplexer/demultiplexer and an ONU.

Embodiments of the present invention further provide a method for realizing the multicast service and cable TV (CATV) broadcasting, which can decrease the requirements for the processing capability of an OLT and save the bandwidth resource of a WDM-PON system greatly.

A WDM-PON includes an OLT, a multiplexer/demultiplexer and n ONUs.

The OLT is configured to carry downstream unicast data respectively transmitted to the n ONUs onto optical signals having different wavelengths, carry one or more channels of multicast service data respectively onto one or more optical signals having specific wavelengths, multiplex the optical signals having different wavelengths and the optical signals having specific wavelengths into one optical signal, and transmit the optical signal to the multiplexer/demultiplexer.

The multiplexer/demultiplexer is configured to divide the optical signals having different wavelengths from the OLT, perform power allocation on the optical signals having specific wavelengths for carrying the multicast service data, and wavelength-selectively output the optical signals carrying the downstream unicast data of the n ONUs.

The n ONUs are respectively configured to process the multicast service data outputted from the multiplexer/demultiplexer so as to obtain the multicast service data and their own downstream unicast data respectively.

An OLT includes an OLT downstream processing module, being configured to carry downstream unicast data, respectively transmitted to n ONUs, onto optical signals having different wavelengths, carry one or more channels of multicast service data respectively onto one or more specific optical signals with wavelengths, multiplex the optical signals having different wavelengths and the optical signals having specific wavelengths into one optical signal, and transmit the optical signal to a multiplexer/demultiplexer.

The multiplexer/demultiplexer according to an embodiment of the present invention includes a coarse wavelength demultiplexer, configured to divide a received optical signal into one or more channels of optical signals having specific wavelengths carrying the multicast service and optical signals for carrying downstream unicast data of each of the ONUs.

The multiplexer/demultiplexer further includes a 1:n AWG, being configured to divide the optical signals, which carry the downstream unicast data of each of the ONUs, from the coarse wavelength demultiplexer to obtain n channels of optical signals having different wavelengths, and route the optical signals having different wavelengths to n output terminals of the AWG respectively.

The multiplexer/demultiplexer further includes a splitter with a splitting ratio of 1:a, being configured to perform power allocation on the optical signals having specific wavelengths from the coarse wavelength demultiplexer, split the power of the optical signals into a portions, and output the a portions of the split optical signals to a combiners respectively.

The multiplexer/demultiplexer further includes a combiners, each of which being connected to one output terminal of the AWG and one output terminal of the splitter, and being configured to couple the optical signals having specific wavelengths from the splitter to a output branches of the AWG.

n is a natural number, and a is a natural number that is larger than 1 and less than or equal to n.

The ONU according to an embodiment of the present invention includes an ONU downstream processing module, which is configured to process the signal from the corresponding output terminal of the multiplexer/demultiplexer and obtain the downstream unicast data corresponding to the ONU itself and the multicast service data respectively.

A method for implementing multicast service in a WDM-PON system includes:
an OLT separating, from downstream data of an superior equipment, multicast service data and each channel of downstream unicast data transmitted to at least one ONU;
the OLT carrying the multicast service data onto an optical signal with specific wavelength and carrying the downstream unicast data of at least one ONU onto at least one optical signal having predetermined wavelengths;
the OLT multiplexing the optical signal with specific wavelength and the at least one optical signal carrying the downstream unicast data of each of the ONUs, and transmitting the multiplexed signal to the multiplexer/demultiplexer;
the multiplexer/demultiplexer separating, from a received optical signal, the optical signal having specific wavelength carrying the multicast service data and the at least one optical signal carrying the downstream unicast data of each of the ONUs according to wavelengths, outputting the optical signal with specific wavelength carrying the multicast service data to part or all of the at least one ONUs, and outputting the at least one optical signals carrying the downstream unicast data of the ONUs respectively to the corresponding ONUs; and
the ONUs separating, from the received optical signals, the optical signal having specific wavelength carrying the multicast service data and their own optical signals carrying the downstream unicast data respectively, obtaining, after performing optical/electrical conversion and demodulation on both of the optical signals, the multicast service data and their own downstream unicast data, and transmitting the multicast service data to the lower stage equipment for further process.

A method for realizing cable television (CATV) broadcasting in a WDM-PON network includes:
an OLT receiving an optical signal having specific wavelength, which carries a CATV broadcast signal, from an superior equipment;
the OLT amplifying the received optical signal having specific wavelength carrying the CATV broadcast signal, through an optical amplifier;
the OLT multiplexing the optical signal having specific wavelength carrying the CATV broadcast signal, which has been optically amplified, and optical signals carrying downstream unicast data of each of ONUs, and transmitting the multiplexed signal to a multiplexer/demultiplexer;
the multiplexer/demultiplexer separating, from a received optical signal, the optical signal having specific wavelength carrying the CATV broadcast signal and the at least one optical signal carrying the downstream unicast data of each of the ONUs according to wavelength, concurrently outputting the optical signal with specific wavelength carrying the CATV broadcast signal to part or all of the ONUs, and outputting the at least one optical signal carrying the downstream unicast data of each of the ONUs to corresponding ONUs respectively; and
the ONUs separating, from the received optical signals, the optical signal with specific wavelength carrying the CATV broadcast signal and the optical signals carrying their own downstream unicast data, obtaining an electrical CATV broadcast signal after performing optical/electrical conversion on the optical signal with specific wavelength carrying the CATV broadcast signal, and transmitting the electrical signal to a lower stage equipment for further process, meanwhile, obtaining their own downstream unicast data after performing optical/electrical conversion on the optical signals carrying their own downstream unicast data, and transmitting the electrical signals to a lower stage equipment for further process.

It can be seen from the above that, in the WDM-PON system according to the embodiments of the present invention and in the process for realizing multicast service according to the method of the embodiments of the present invention, multicast service can be carried onto one or more optical signals having specific wavelengths, and thus the problem of the wasting of the bandwidth resource caused by the manner of in-band multiple replicas in the related art can be effectively solved, and the bandwidth resource of the system can be effectively saved. Moreover, because there is no need to support a complex multicast protocol in the OLT in the WDM-PON system, the complexity of the OLT can be reduced.

Furthermore, because, conventionally, the traffic of multicast service is large and its priority is high, the quality of service of other real-time services (for example, VOIP) can be ensured by separating multicast service to use a single wavelength for transmission, thereby the quality of service of the WDM-PON system can be ensured much better.

### BRIEF DESCRIPTION OF THE DRAWINGS

FIG. 1 is a schematic diagram of the infrastructure of the current PON system;

FIG. 2 is a schematic diagram of the function of a multiplexer/demultiplexer used in a WDM-PON according to a preferred embodiment of the present invention;

FIG. 3 is a schematic diagram of the infrastructure of a WDM-PON according to a preferred embodiment of the present invention;

FIG. 4 is a schematic diagram of the system structure for realizing multicast service in a WDM-PON according to another preferred embodiment of the present invention;

FIG. 5 is a schematic diagram of the system structure for realizing CATV service and multicast service in a WDM-PON according to another preferred embodiment of the present invention;

FIG. 6 is a schematic diagram of the internal structure of a multiplexer/demultiplexer according to a preferred embodiment of the present invention;

FIG. 7 is a schematic diagram of the internal structure of a multiplexer/demultiplexer according to another preferred embodiment of the present invention; and

FIG. 8 is a flowchart of a method for realizing multicast service according to a preferred embodiment of the present invention.

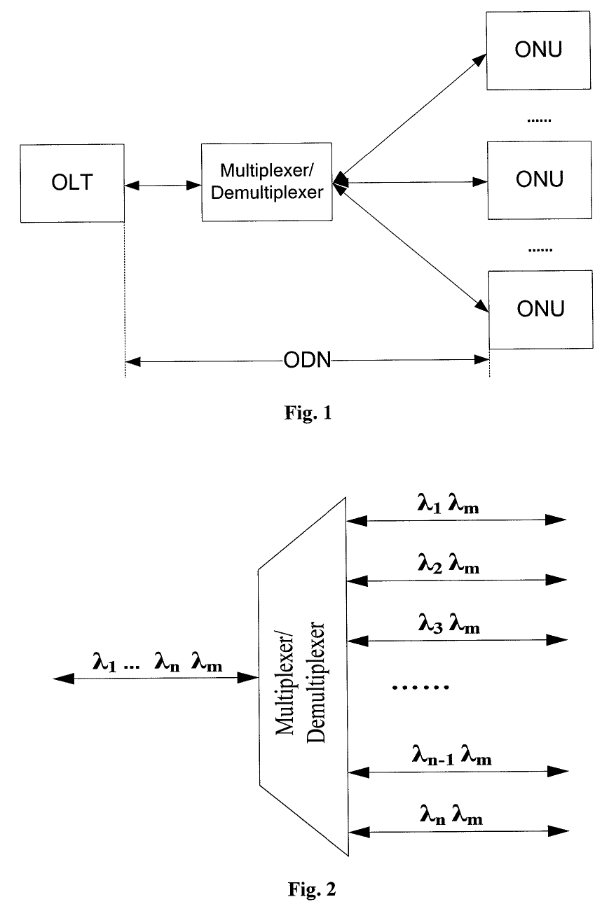

### DETAILED DESCRIPTION

In order to clarify the objects, technical solutions and advantages of the present invention, detailed descriptions to the embodiments of the present invention are provided below with reference to the accompanying drawings.

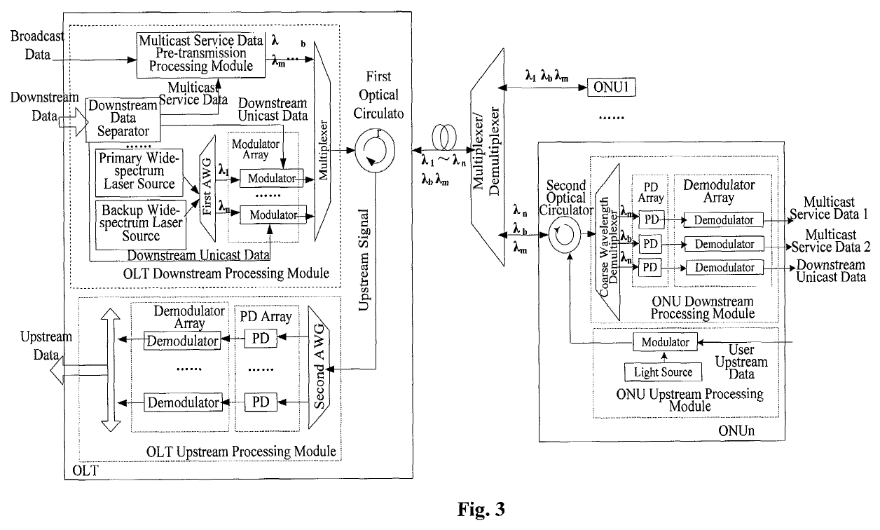

A preferred embodiment of the present invention provides a WDM-PON system for supporting multicast service, for example, a WDM-PON system for supporting multicast service and/or broadcast service and/or cable television (CATV) service. FIG. 3 shows the infrastructure of the WDM-PON system according to the embodiment. As shown in FIG. 3, the WDM-PON system mainly includes: an OLT, a multiplexer/demultiplexer, n ONUs and fibers connecting the OLT, the multiplexer/demultiplexer and the n ONUs, where n is a natural number.

In the downstream direction, the OLT is configured to carry n channels of downstream unicast data to be respectively transmitted to the n ONUs into n optical signals respectively having different wavelengths, carry one or more channels of multicast service data into one or more optical signals respectively having specific wavelengths, multiplex the optical signals respectively having different wavelengths and the optical signals having specific wavelengths into one optical signal, and output the one optical signal to the multiplexer/demultiplexer. In the upstream direction, the OLT is configured to separate upstream optical signals from each of the ONUs, recover upstream data of each of the users after performing detection and demodulation on the upstream optical signals, and output the retrieved upstream data to a superior equipment.

The function of the multiplexer/demultiplexer is shown in FIG. 2. In the downstream direction, the multiplexer/demultiplexer is configured to: separate the optical signals having different wavelengths received from the OLT; perform power allocation or power splitting on an optical signal having specific wavelength which carries multicast service, such as an optical signal having a wavelength of λₘ, that is, concurrently output the optical signal having specific wavelength through part or all of output terminals; and selectively outputting, according to wavelength, n channels of the optical signals having other wavelengths which carry downstream unicast data of each of the ONUs respectively, that is, output the optical signals of different wavelengths through predetermined corresponding output terminals respectively. In the upstream direction, the multiplexer/demultiplexer is configured to multiplex n channels of upstream signals, which have different wavelengths and are from different ONUs respectively, to obtain an optical signal, and output the optical signal to the OLT.

In the downstream direction, an ONU is configured to process a signal from one of the output terminals of the multiplexer/demultiplexer to obtain the multicast service data and the downstream unicast data corresponding to the ONU respectively. In the upstream direction, the ONU is configured to carry its upstream data onto an optical signal having predetermined wavelength, and output the optical signal to the multiplexer/demultiplexer.

Still referring to FIG. 3, the OLT further includes an OLT downstream processing module, an OLT upstream processing module and a first optical circulator.

The first optical circulator is connected to the OLT downstream processing module, the OLT upstream processing module and the multiplexer/demultiplexer, and is configured to output the downstream optical signal from the OLT downstream processing module to the multiplexer/demultiplexer, and output the upstream optical signal from the multiplexer/demultiplexer to the OLT upstream processing module.

The OLT downstream processing module includes a downstream data separator, configured to separate, from downstream service data, the multicast service data and n channels of downstream unicast data respectively transmitted to the n ONUs.

The OLT downstream processing module further includes a multicast service data transmission pre-processing module which is configured to receive broadcast data (for example, the CATV signal) from the superior equipment and/or multicast service data from the downstream data separator, and perform process and amplification on the broadcast data and/or multicast service data to obtain one or more optical signals having one or more specific wavelengths, which carry one or more channels of the multicast service data.

The multicast service data transmission pre-processing module optically amplifies the optical signal from the superior equipment, which carries the broadcast data, directly by an optical amplifier. For the one or more channels of the multicast service data from the downstream data separator, the multicast service data transmission pre-processing module modulates the multicast service data into one or more optical signals having specific wavelengths, and performs related processes to the modulated optical signals. Accordingly, the multicast service data transmission pre-processing module further includes an optical amplifier for optically amplifying the broadcast data, and/or one or more lasers for generating optical signals having specific wavelengths, and one or more modulators for modulating the multicast service data into the optical signals having specific wavelengths. The functions of the lasers and the modulators could be implemented in a separate Direct Modulation Laser (DML).

The OLT downstream processing module further includes a primary wide-spectrum laser source for generating a wide-spectrum optical signal.

To ensure the reliability of the system, the WDM-PON may further include an alternate wide-spectrum laser source for providing backup wide-spectrum optical signals when the primary wide-spectrum laser source fails.

The OLT downstream processing module further includes a first Array Waveguide Grating (AWG) which is configured to process a wide-spectrum optical signal outputted from the primary wide-spectrum laser source or backup wide-spectrum laser source to generate n channels of optical signals, each of which has respective wavelength among the wavelengths of λ₁˜λₙ, thus providing laser sources having different wavelengths for an optical modulator array.

The OLT downstream processing module further includes an optical modulator array including n modulators, which is configured to modulate the downstream unicast data corresponding to the n ONUs from the downstream data separator into the n channels of optical signals, which are outputted from the first AWG and have wavelengths of λ₁˜λₙ, respectively.

The OLT downstream processing module further includes a multiplexer. The multiplexer is configured to multiplex the one or more optical signals having special wavelengths (for example, λₘ, λ_{b} and so on) and n channels of optical signals having the wavelengths of λ₁˜λₙ respectively, into an optical signal; and output the multiplexed optical signal to the first optical circulator. The one or more optical signals having special wavelengths (for example, λₘ, λ_{b} and so on) may carry the multicast service data; and the n channels of optical signals may carry the downstream unicast data of the n ONUs, respectively. The multiplexer may be a coupler, an AWG or other multiplexing equipments.

The OLT upstream processing module includes a second AWG, which is configured to divide the upstream optical signal of the first optical circulator to obtain n channels of optical signals, which have wavelengths of λ₁˜λₙ, respectively.

The OLT upstream processing module further includes a Photodiode or Photo Detector (PD) array, i.e., PD array. The PD array includes n PDs configured to convert one channel of upstream optical signal from the second AWG to an electrical signal, respectively.

The OLT upstream processing module further includes a demodulator array. The demodulator array consists of n demodulators, which are configured to demodulate electrical signals outputted from the Photodiode or PD array and recover the upstream data of each of the ONUs, respectively.

The ONU in the WDM-PON shown in FIG. 3 includes an ONU downstream processing module, an ONU upstream processing module and a second optical circulator.

The second optical circulator is connected to the ONU upstream processing module, the ONU downstream processing module and the multiplexer/demultiplexer. The second optical circulator is configured to output an upstream optical signal from the ONU upstream processing module to the multiplexer/demultiplexer, and output a downstream optical signal from the multiplexer/demultiplexer to the ONU downstream processing module.

The ONU downstream processing module includes a coarse wavelength demultiplexer. The coarse wavelength demultiplexer is configured to divide an optical signal outputted from the multiplexer/demultiplexer to obtain the optical signals having different wavelengths. The divided optical signals include an optical signal having a wavelength among λ₁˜λₙ and optical signals having specific wavelengths, such as λₘ and/or λ_{b}. The optical signal having a wavelength among λ₁˜λₙ is used for carrying downstream unicast data corresponding to the ONU, and the optical signals having specific wavelengths are used for carrying multicast service.

The ONU downstream processing module further includes a PD array consisting of a plurality of PDs, the number of which is determined based on the number of multicast services. If x channels of multicast service are carried, the PD array may include x+1 PDs, in which, one of the PDs is configured to convert the optical signal carrying downstream unicast data corresponding to the ONU, among the optical signals having wavelengths of λ₁˜λₙ from the coarse wavelength demultiplexer, into an electrical signal, and another x PDs are respectively configured to convert the optical signals having specific wavelengths from the coarse wavelength demultiplexer, which carry channels of the multicast services, into electrical signals.

The ONU downstream processing module further includes a demodulator array consisting of a plurality of demodulators, the number of which corresponds to the number of the PDs in the PD array. One of the demodulators is configured to demodulate the electrical signal carrying the downstream unicast data of the ONU to obtain the downstream unicast data of the ONU, and another demodulators are respectively configured to demodulate the electrical signals outputted from the PD array, which carry channels of the multicast service data, to obtain each channel of the multicast service data.

The ONU upstream processing module includes a modulator, which is configured to modulate the upstream data of the ONU into an optical signal.

The optical signal is necessary for the ONU to transmit the upstream data. The optical signal may be either from the OLT or generated by the ONU itself. If the optical signal is generated by the ONU itself, the ONU upstream processing module needs to include a light source, as shown in FIG. 3.

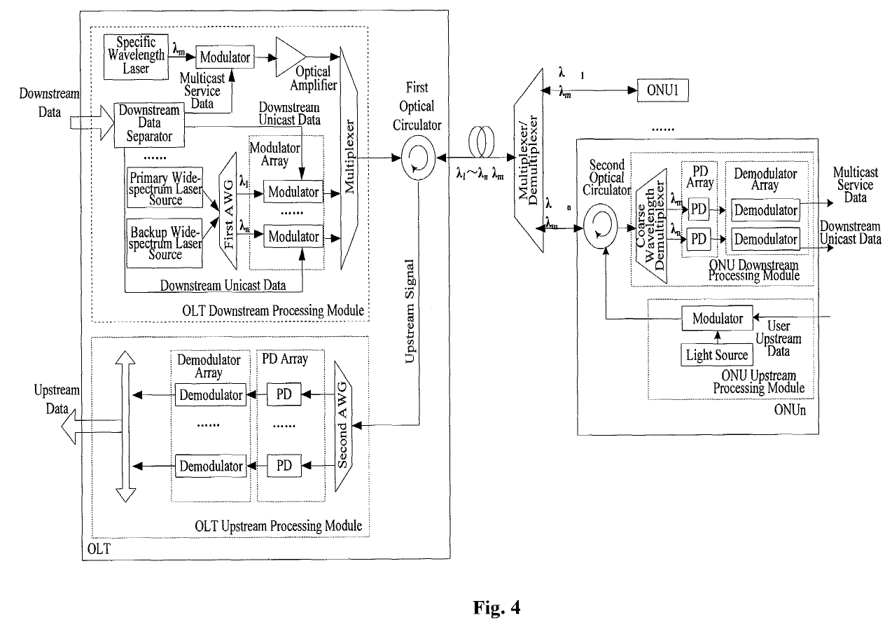

A dynamic operating process for realizing multicast service by the WDM-PON is described, in combination with FIG. 4, through another preferred embodiment of the invention.

As shown in FIG. 4, in the OLT, the process for realizing multicast service using the WDM-PON includes: multicast service data is firstly extracted from data stream from the superior equipment by the downstream data separator; the extracted multicast service data is modulated by the modulator into an optical signal having the wavelength of λₘ outputted from a specific wavelength laser; the modulated optical signal is amplified by an optical amplifier; and the amplified optical signal having the wavelength of λₘ, which carries the multicast service data, is multiplexed by the multiplexer with the n channels of optical signals, which have the wavelengths of λ₁˜λₙ, respectively, and carry the downstream unicast data of each of the ONUs respectively, so as to obtain a multiple-wavelength optical signal having the wavelengths of λ₁˜λₙ and λₘ; and the multiple-wavelength optical signal is transmitted to the multiplexer/demultiplexer through the first optical circulator. The above specific wavelength laser, modulator and optical amplifier constitute the multicast service data transmission pre-processing module shown in FIG. 3.

The multiplexer/demultiplexer divides the received optical signal to obtain optical signals at different wavelengths, concurrently outputs the optical signal having the wavelength of λₘ, which carries the multicast service data, through n output terminals; and outputs the n channels of optical signals, which have the wavelengths of λ₁˜λₙ, respectively, and carry the downstream unicast data of each of the ONUs, respectively, to corresponding output terminals, respectively. As such, the optical signal respectively outputted from each of the output terminals of the multiplexer/demultiplexer at least includes the optical signal having the wavelength of λₘ and one channel of optical signal among the optical signals having the wavelengths of λ₁˜λₙ. The optical signal having the wavelength of λₘ carries the multicast service data; and the optical signals having the wavelengths of λ₁˜λₙ carry the downstream unicast data of each of the ONUs, respectively. For example, the optical signal outputted from the output terminal 1 includes two wavelengths of λ₁ and λₘ, the optical signal outputted from the output terminal 2 includes two wavelengths of λ₂ and λₘ, and the optical signal outputted from the output terminal n includes two wavelengths of λₙ and λₘ. Subsequently, the n output signals are transmitted to the n ONUs of the WDM-PON system, respectively.

In each of the ONUs, the ONU downstream processing module divides the optical signal from the multiplexer/demultiplexer to obtain the optical signal having the wavelength of λₘ, which carries the multicast service data, and one channel of optical signal carrying the downstream unicast data of the ONU among the optical signals having the wavelengths of λ₁˜λₙ. After the two channels of optical signals are converted into electrical signals and further demodulated, respectively, the multicast service data and the unicast data corresponding to the ONU itself could be obtained.

Meanwhile, in order to realize the multicast service, the OLT is capable of capturing a request for joining a multicast group from an ONU, and implementing the function of a multicast agent in which the OLT determines, according to the result of the authentication returned from an superior multicast server, whether the ONU has the right to receive data of the requested multicast group, and sends a multicast service control message to the ONU according to the result of the determination. The ONU filters data of the multicast group, which is permitted by the OLT to be received by the ONU, according to the multicast service control message from the OLT, and discards data of the multicast group, which is not permitted by the OLT to be received by the ONU. After the ONU filters the data of the multicast group permitted by the OLT, the data of the multicast group is transmitted to a subordinate equipment for further process.

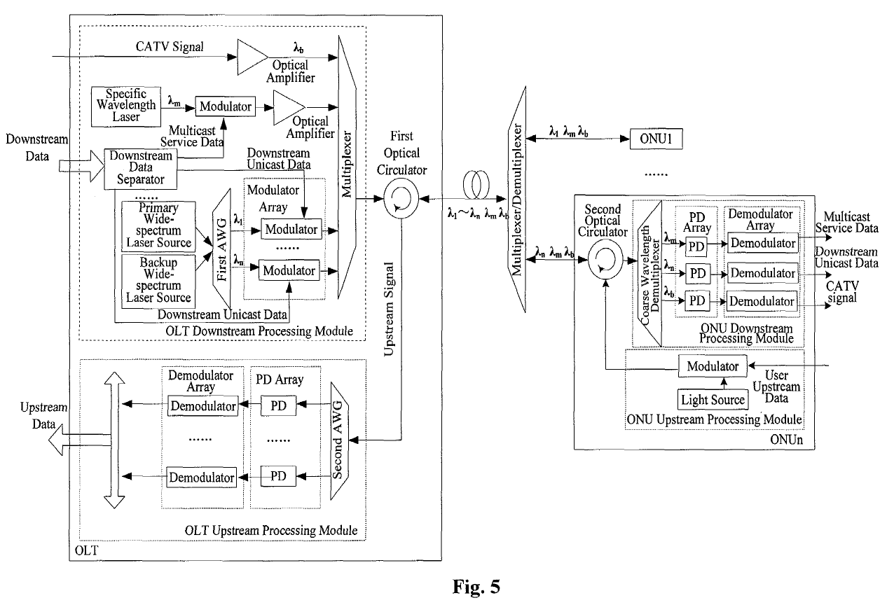

The WDM-PON system shown in FIG. 3 may further provide CATV service. FIG. 5 shows a schematic diagram of the system structure of a WDM-PON capable of concurrently providing CATV service and multicast service according to another preferred embodiment of the present invention.

As shown in FIG. 5, the WDM-PON, which provides CATV service and multicast service for the ONUs, is made the following improvements on the basis of the structure as shown in FIG. 4.

For the OLT, an optical amplifier for connecting the outputting terminal to the multiplexer is added to amplify an optical signal having the wavelength of λ_{b}, which carries a CATV signal from the outside. As shown in FIG. 5, the specific wavelength laser, the modulator, the optical amplifier connected to the modulator and the optical amplifier for amplifying the CATV signal constitute the multicast service data transmission pre-processing module shown in FIG. 3.

For the multiplexer/demultiplexer, in the downstream direction, the multiplexer/demultiplexer further performs power allocation on the optical signal having the specific wavelength, i.e., λ_{b}, which carries the CATV signal, among the optical signals from the OLT. That is, the optical signal with the specific wavelength of λ_{b} is concurrently outputted to each of the output terminals. As such, the optical signal outputted from each output terminal of the multiplexer/demultiplexer includes the optical signal with the wavelength of λₘ which carries the multicast data, the optical signal with the wavelength of λ_{b} which carries the CATV signal, and one channel of optical signal among the optical signals having the wavelengths of λ₁˜λₙ which carry the downstream unicast data of each of the ONUs.

Furthermore, for the ONU, the optical signal having the wavelength of λ_{b} which carries the CATV signal is divided by the coarse wavelength division multiplexer. The PD array and the modulator array further include a PD and a modulator for performing optical/electrical conversion and demodulation to the optical signal having the wavelength of λ_{b}, which carries the CATV signal, so as to obtain the CATV data at each of the ONUs.

In the process for realizing CATV service, the OLT may realize controllable receipt of CATV service in a similar manner with that for realizing multicast service, such as by transmitting a broadcast control message.

It can be seen from the above process for realizing multicast service, the WDM-PON system may realize multicast or broadcast service. Further, because only one or more divided wavelengths are used for carrying one or more channels of the multicast service data in the above WDM-PON system, the problem in the related art that the number of replicas needs to be consistent with the number of users to whom the multicast service data is to be transmitted can be effectively avoided, thereby the bandwidth resource of the WDM-PON system can be greatly saved. Further, the load scheduled by the OLT can be reduced, and there is no need to support a complex multicast scheduling protocol in the OLT, thereby the complexity of the system is reduced.

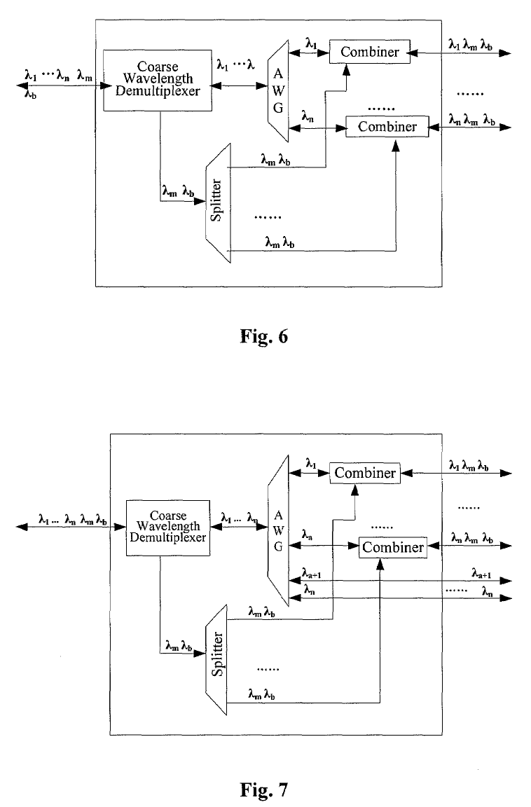

It can be seen from the above embodiments that the multiplexer/demultiplexer used in the present WDM-PON system is different from that used in the related WDM-PON system. In order to realize the present WDM-PON system, in a preferred embodiment of the present invention, a novel multiplexer/demultiplexer is provided, which is used in the above WDM-PON system, has the function of an AWG, and is capable of broadcasting optical signals having some specific wavelengths. FIG. 6 shows the structure of such multiplexer/demultiplexer.

As shown in FIG. 6, the multiplexer/demultiplexer in the present embodiment includes a coarse wavelength demultiplexer, which is configured to divide the received optical signals to obtain optical signals having specific wavelengths (for example, λ_{b} and/or λₘ and/or other specific wavelengths) carrying the multicast service and optical signals carrying the downstream unicast data of each of the ONUs.

The multiplexer/demultiplexer further includes a 1:n AWG, being configured to divide the optical signals with the wavelengths of λ₁˜λₙ from the coarse wavelength demultiplexer to obtain n channels of optical signals respectively having respective wavelength among the wavelengths of λ₁˜λₙ, and route the optical signals to the n output terminals of the AWG, where n corresponds to the number of the ONUs in the WDM-PON system.

The multiplexer/demultiplexer further includes a splitter having a splitting ratio of 1:n. The splitter is configured to perform power allocation on the optical signals having specific wavelengths (for example, λ_{b} and/or λₘ and/or other specific wavelengths) from the coarse wavelength demultiplexer, split the power of the optical signals into n portions, and output the n portions of the split optical signals to n combiners, respectively.

The multiplexer/demultiplexer further includes n combiners, each of which is connected to one output terminal of the AWG and one output terminal of the splitter, for coupling the optical signals having specific wavelengths from the splitter to each of the output branches of the AWG.

It can be seen from the above that both the optical signals having specific wavelengths (for example, λ_{b} and/or λₘ and/or other specific wavelengths), which carry the multicast service, and the n channels of the optical signals, which carry the unicast data of each of the ONUs, could be obtained at each of the n output terminals of the multiplexer/demultiplexer shown in FIG. 6, therefore the multiplexer/demultiplexer can be used to the WDM-PON system.

It should be understood for a person skilled in the art that other alternative solutions can be used to substitute the multiplexer/demultiplexer in the present embodiment. For example, the functions of the coarse wavelength demultiplexer, the splitter and the combiners may be integrated into a separate AWG, and the multiplexer/demultiplexer may be realized with the coarse wavelength demultiplexer, the splitter, the combiners, a N:N Wavelength Grating Router (WGR), etc.

As stated above, each of the n output terminals of the multiplexer/demultiplexer in FIG. 6 includes the optical signals having specific wavelengths for carrying the multicast service. However, in some special circumstances, some ONUs in the WDM-PON system may not support the multicast service, and thus it is not necessary to concurrently output the multicast service to all of the output terminals of the multiplexer/demultiplexer. A simplified multiplexer/demultiplexer according to another preferred embodiment of the present invention is provided in FIG. 7. The multiplexer/demultiplexer includes a coarse wavelength demultiplexer, which is configured to divide the received optical signals to obtain optical signals having specific wavelengths (for example, λ_{b} and/or λₘ and/or other specific wavelengths) for carrying the multicast service and optical signals for carrying the downstream unicast data of each of the ONUs.

The multiplexer/demultiplexer further includes a 1:n AWG, which is configured to divide the optical signals having the wavelengths of λ₁˜λₙ from the coarse wavelength demultiplexer to obtain n channels of optical signals, respectively, having respective wavelength among the wavelengths of λ₁˜λₙ, and route the optical signals to the n output terminals of the AWG, where n corresponds to the number of the ONUs in the WDM-PON system.

The multiplexer/demultiplexer further includes a splitter having a splitting ratio of 1:a. The splitter is configured to perform power allocation on the optical signals having specific wavelengths (for example, λ_{b} and/or λₘ) from the coarse wavelength demultiplexer, split the power of the optical signals into a portions, and output the a portions of the split optical signals to a combiners, respectively, where a is a natural number that is larger than or equal to 1 and smaller than n and corresponds to the number of the ONUs supporting the multicast service in the WDM-PON system.

The multiplexer/demultiplexer further includes a combiners, each of which is connected to one output terminal of the AWG and one output terminal of the splitter, for coupling the optical signals having specific wavelengths from the splitter to a output branches of the AWG.

It can be seen from the above that because the above multiplexer/demultiplexer may concurrently transmit the optical signals carrying the multicast service to each ONU of the WDM-PON system by performing power allocation, it is possible to transmit multicast or broadcast data at a separate wavelength, thereby the bandwidth resource of the system can be greatly saved.

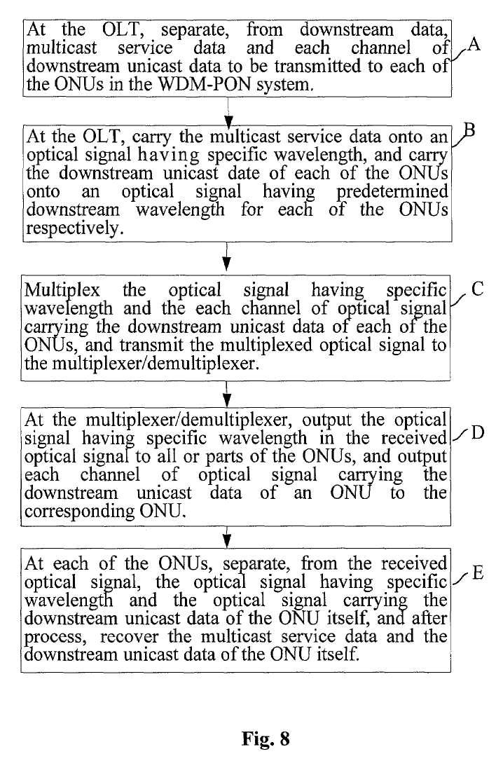

Besides the above WDM-PON system and multiplexer/demultiplexer, a method for realizing the multicast service using the WDM-PON system is provided according to another preferred embodiment of the invention. As shown in FIG. 8, the method mainly includes the following steps.

Step A: the OLT separates, from downstream data from the superior equipment, multicast service data and each channel of downstream unicast data to be transmitted to each of the ONUs in the WDM-PON system.

Step B: the OLT carries the multicast service data onto an optical signal having specific wavelength, and carries the downstream unicast date of each of the ONUs onto an optical signal having predetermined downstream wavelength for each of the ONUs respectively.

Step C: the optical signal having specific wavelength and the each channel of optical signal carrying the downstream unicast data of each of the ONUs are multiplexed and transmitted to the multiplexer/demultiplexer in the ONU.

Step D: the multiplexer/demultiplexer separates, from the received optical signal, the optical signal having specific wavelength and each channel of optical signal carrying the downstream unicast data for each of the ONUs according to wavelength, outputs the optical signal having specific wavelength to all or parts of the ONUs, and outputs each channel of optical signal carrying the downstream unicast data of an ONU to the corresponding ONU.

Step E: each of the ONUs in the WDM-PON system separates, from the received optical signal, the optical signal having specific wavelength and the optical signal carrying the downstream unicast data of the ONU itself, performing optical/electrical conversion and demodulation to both of the optical signals to obtain the multicast service data and the downstream unicast data of the ONU itself, and transmits the multicast service data to the lower equipment for further process.

Furthermore, as stated above, the OLT can control whether an ONU can receive the multicast service data, by transmitting a corresponding control message to the ONU.

The multicast service may be general multicast service, broadcast service, or CATV service. Particularly, for CATV service, the OLT transmits a broadcast control message to the ONU to prohibit the ONU from receiving the CATV broadcast signal or permit the ONU to receive the CATV broadcast signal. After receiving the broadcast control message, if the broadcast control message prohibits the ONU from receiving the CATV broadcast signal, the ONU turns off an optical/electrical converter so as not to receive the CATV broadcast signal, and if the broadcast control message permits the ONU to receive the CATV broadcast signal, the ONU turns on the optical/electrical converter so as to receive the CATV broadcast signal.

It can be seen from the above that, through the method, the multicast or broadcast can be realized in the WDM-PON system. Because the multicast service is only transmitted once at a specific wavelength in the WDM-PON system, the problem of the wasting of the bandwidth resource caused by the manner of bandwidth multiple replicas in the related art can be solved. The bandwidth resource of the system can be greatly saved, and the complexity of the OLT can be reduced for there is no need to apply a complex multicast protocol in the OLT.

What is claimed is:

1. A Passive Optical Network (PON) system, comprising an Optical Line Terminal (OLT), a multiplexer/demultiplexer and n Optical Network Units (ONUs), n being a natural number, wherein
the OLT is configured to modulate and transmit downstream optical signals, wherein the downstream optical signals comprise a downstream optical signal having at least one first wavelength modulated with downstream unicast data and a downstream optical signal having a specific wavelength modulated with multicast service data;
the multiplexer/demultiplexer is configured to divide the downstream optical signals received from the OLT to obtain an optical signal having a specific wavelength, and output a plurality of channels of optical signals having the specific wavelength by performing power allocation on the obtained optical signal having the specific wavelength; and
at least one of the n ONUs is configured to receive optical signals from the multiplexer/demultiplexer and recover the multicast service data from a received optical signal having the specific wavelength.

2. The PON system according to claim 1, wherein,
the at least one of the n ONUs is configured to convert the received optical signal having the specific wavelength into electrical signal, demodulate the electrical signal, and obtain the multicast service data by filtering data of a multicast group which permitted by the OLT to be received by the ONU and discarding data of a multicast group which is not permitted by the OLT to be received by the ONU.

3. The PON system according to claim 1, wherein the OLT is further configured to receive from a superior equipment an optical signal having a second wavelength which carries a CATV broadcast signal, amplify the received optical signal having the second wavelength through an optical amplifier, and transmit the amplified optical signal having the second wavelength to the multiplexer/demultiplexer.

4. An Optical Line Terminal (OLT), comprising:
a multicast data transmission pre-processing module, configured to modulate multicast service data onto an optical signal having a first wavelength;
n modulators, each of the n modulators configured to modulate downstream unicast data to be transmitted to an ONU onto an optical signal having one of n wavelengths, wherein the n is a natural number that is larger than or equal to 1 and the n wavelength is different from the first wavelength;
a multiplexer/demultiplexer, configured to multiplex the modulated optical signal from the multicast data transmission pre-processing module and the modulated optical signals from the n modulators.

5. The OLT according to claim 4, the OLT further comprising:
a downstream data separator, connected to the multicast data transmission pre-processing module, the downstream data separator configured to separate the downstream service data to obtain the multicast service data to be broadcasted or multicasted and the downstream unicast data to be respectively transmitted to the n ONUs.

6. The OLT according to claim 4, the OLT further comprising:
a wide-spectrum laser source, configured to generate a wide-spectrum optical signal;
a first Array Waveguide Grating (AWG), connected to the n second modulators, the first AWG configured to splitting the wide-spectrum optical signal from the first wide-spectrum laser source to generate n channels of optical signals, each of the n channels of optical signals having one of the n wavelengths.

7. The OLT according to claim 6, the OLT further comprising:
a second wide-spectrum laser source, connected to the first AWG, the second wide-spectrum laser source configured to provide a backup wide-spectrum optical signal for the AWG when the first wide-spectrum laser source fails.

8. An apparatus, comprising:
a coarse wavelength demultiplexer (CWDM), configured to divide a channel of received optical signal into a plurality of channels of optical signals, the wavelengths of the channel of received optical signal comprising a specific wavelength for carry multicast service data and a first wavelength for carrying downstream unicast data, the plurality of channels of optical signals comprising a channel of optical signal having a specific wavelength for carrying multicast service data and a channel of optical signal having other different wavelength from the specific wavelength for carrying downstream unicast data;
a splitter with a splitting ratio of 1:a, configured to split the channel of optical signal having the specific wavelength for carrying multicast service data from the CWDM by performing power allocation, into a portions, each of the a portions of optical signals having the specific wavelength for carrying multicast service data being output to a corresponding ONU.

9. The apparatus according to claim 8, the plurality of channels of optical signals further comprising a channel of optical signals having n wavelengths for carrying downstream unicast data, the n wavelengths being different from the specific wavelength and the n being a natural number that is larger than 1; and
the apparatus further comprising a third 1:n AWG and a combiners, the a being a natural number that is smaller than or equal to n, wherein, the third 1:n AWG, connected to the CWDM, is configured to divide the channel of optical signal having n wavelengths for carrying downstream unicast data from the CWDM, to obtain n channels of optical signals,
each of which has one of the n wavelength, and output a channels of the optical signals among the n channels of optical signals to the a combiners respectively; wherein, each of the a combiners is configured to couple the optical signal having the specific wavelength for carrying multicast service data from the splitter with a channel of optical signal having one of the n wavelengths for carrying downstream unicast data from the CWDM to output to corresponding ONU.

10. An Optical Network Unit (ONU), comprising:
a coarse wavelength demultiplexer (CWDM), configured to divide a channel of optical signal having at least two wavelengths from the downstream optical signal, a first wavelength of the at least two wavelengths carrying downstream unicast data, and a specific wavelength of the at least two wavelengths carrying multicast service data;
at least two photodiodes, a first photodiode of the at lest two photodiodes being configured to convert an optical signal having the first wavelength from the CWDM into a first electrical signal, and a second photodiode of the at lest two photodiodes is configured to convert an optical signal having the specific wavelength into a second electrical signal; and
at least two demodulators, wherein a first demodulator of the at least two demodulators is configured to demodulate the first electrical signal to obtain the downstream unicast data for the ONU, and a second demodulator of the at least two demodulators is configured to demodulate the second electrical signal to obtain the multicast service data.

11. The ONU according to claim 10, further comprising a second optical circulator and an ONU upstream processing module; wherein,
the ONU upstream processing module is configured to modulate upstream data onto an optical signal having a corresponding wavelength;
the second optical circulator, connected to a multiplexer/demultiplexer, the CWDM and the ONU upstream processing module, is configured to output the channel of optical signal having at least two wavelengths from a downstream optical signal received from the multiplexer/demultiplexer to the CWDM, and output a upstream optical signal from the ONU upstream processing module to the multiplexer/demultiplexer.

12. A method for implementing service in a Passive Optical Network (PON), comprising:
an Optical Line Terminal (OLT) transmitting an a channel of downstream optical signals having at least two wavelengths to a multiplexer/demultiplexer, a first downstream optical signal having a first wavelength of at least two wavelengths being modulated with downstream unicast data and a second downstream optical signal having a specific wavelength of the at least two wavelengths being modulated with multicast service data;
n ONUs receiving optical signals from the multiplexer/demultiplexer, wherein the optical signals received by each of at least two of the n ONUs comprise an optical signal having the specific wavelength modulated with multicast service data, and the ONU which receives the optical signals having the specific wavelength modulated with multicast service data recovers the multicast service data.

13. The method for implementing multicast service according to claim 12, further comprising:
the OLT capturing a request for joining a multicast group from an ONU, and implementing the function of a multicast agent in which the OLT performs authentication, determines whether the ONU has the right to receive data of the requested multicast group according to the result of the authentication, and sends a multicast service control message to the ONU according to the result of the determination; and
the ONU filtering data of the multicast group, which is permitted by the OLT to be received by the ONU, according to the multicast service control message from the OLT, and discarding data of the multicast group, which is not permitted by the OLT to be received by the ONU.

14. The method for implementing multicast service according to claim 12, further comprising:
the OLT receiving from a superior equipment an optical signal having a second wavelength, which carries a CATV broadcast signal, amplifying the received optical signal having the second wavelength through an optical amplifier, and transmitting the amplified optical signal having the second wavelength to the multiplexer/demultiplexer;
each of at least two of the n ONUs receiving optical signals comprising an optical signal having the second wavelength and recovering the CATV broadcast signal.
